(19) United States
(12) Patent Application Publication
(10) Pub. No.: US 2010/0325074 A1
(43) Pub. Date: Dec. 23, 2010

(54) REMOTE MONITORING THRESHOLDS

(76) Inventors: Jason W. P. Ng, Suffolk (GB); Tom Mizutani, Nottinghamshire (GB)

Correspondence Address: NIXON & VANDERHYE, PC, 901 NORTH GLEBE ROAD, 11TH FLOOR, ARLINGTON, VA, 22203, US

(21) Appl. No.: 12/919,164

(22) PCT Filed: Feb. 24, 2009
(86) PCT No.: PCT/GB2009/000511

§ 371 Date: Aug. 24, 2010

(30) Foreign Application Priority Data
Feb. 26, 2008 (EP) 08250653.6

(51) Int. Cl. G06F 15/18

(52) U.S. Cl. 706/12

(57) ABSTRACT

Apparatus for generating a threshold value indicative of a status change, comprising a trend projection engine for processing a plurality of sensed values in an order of value size to generate a corresponding predicted value for each of the plurality of sensed values, by reference to a value sequence trend of the plurality of sensed values, a comparator for comparing one or more of the plurality of sensed values against their corresponding predicted values to identify an abnormal sensed value which differs from its corresponding predicted value by a pre-specified amount, and a threshold generator for using the abnormal sensed value to identify the threshold value.

This invention relates to apparatus, systems and methods for the selection and setting of threshold values in remote status monitoring, particularly but not exclusively in the context of the remote monitoring of the wellbeing of persons.

“Telecare” is a term describing the use of technology to enable parties such as care providers (CPs) to monitor the status or wellbeing of persons who may be elderly or otherwise vulnerable (referred herein as customers or Service Users (SUs)), where such SUs remain in their own homes or are otherwise located remote to the CPs.

Various telecare approaches are known. In the most direct method of obtaining customer data, customers wear devices which measure physical or physiological parameters. For example, accelerometer-based equipment worn on the person can provide direct feedback to the CP that the customer has fallen. However this method suffers from being excessively invasive to the customer who may have to have on his person a number of such devices. Compliance is also a problem where the SU is reluctant to cooperate by wearing the device(s).

A preferred approach is to provide ambient sensors fixed within the SU's premises, to monitor the SU's activities. This can be achieved by use of devices which literally keep an eye on the SU, such as video cameras and sound recording devices. However this approach could also be ethically objectionable and invasive; it is also expensive and complicated to set up and monitor.

The present invention has application in any remote monitoring system using any approach i.e. regardless of how the data is obtained. However an exemplary embodiment will be described herein in the main in the context of a telecare system based on a motion sensor-based system.

In a system based on the use of motion sensors and the like of the described exemplary embodiment, the sensed data gathered by the nodes takes the form of positive events (e.g. motions of the SU). The sensed data is analysed to determine if a pre-determined condition is met. As an example, periods of non-movement can be identified by motion sensors so that a period of non-movement exceeding a pre-determined length of time is deemed to be unusual or abnormal, and indicative that the SU has fallen, become immobile or otherwise needs attention.

In the present description, an “inter-event” time period is the length of time elapsed between consecutive events, positive or negative, detected by either the same sensor or all sensors within the dwelling of a particular SU. In the described embodiment, an inter-event generally refers to the time elapsed between positive events sensed by a motion sensing node. In a telecare monitoring system, a threshold value defines the boundary of an acceptable inter-event period. If the sensor, or group of sensors, fails to detect an event beyond a set threshold value, this may be deemed to be an abnormal occurrence deserving attention.

The main problem for the telecare system operator is in deciding what threshold value to adopt, which would trigger an intervening act. As an example, if the threshold value of time elapsed without detected customer activity is exceeded, this may prompt help to be sent to the customer's premises. If the value is set too low, then an excessive number of false alarms will be generated, annoying all concerned and significantly reducing trust in the system. Setting the threshold level too high however, carries the risk of an alarm being raised late which means that assistance would be sent late to the customer needing help.

This is a problem experienced in any remote monitoring activity in fields such as those within telecare context or in the home security arena. Similar problems exist in the industrial sphere, such as the monitoring within industrial production line, or within consumer machinery (such as in cars and aircraft), where parts or entire machines suffer stress and mechanical fatigue through and during use.

In the telecare area in particular, there are various known approaches to the determination of a threshold value. In the first, a fixed value is provided at the outset. This is a prevalent method deployed by telecare operators, where sensors (also here referred to as nodes) have their threshold values either factory pre-set, or set by the parties installing the sensors at the premises or dwellings. The selected threshold value is thus often at best an educated guess about its applicability or accuracy in the particular implementation. Even where the value can be subsequently changed, this is a clumsy and subjective method requiring much trial and error, separate measurement and monitoring before the value can be manually re-set. This method works especially poorly where there are numerous nodes requiring setting, and/or when the context or conditions of use (e.g. time of day, holiday periods in the year) change. The risks of getting it wrong are such that levels are usually set to err on the side of caution.

An alternative is an adaptive approach, where the selected threshold value is personalised to the SU. An example of a system based on the adaptive approach is discussed in the publication by Barnes N, Webster S, Mizutani T, Reeves A, Ng J, Buckland M. “Case Studies from the Liverpool Telecare Pilot”.

This technique involves the system's “learning” the SU's behaviour and habits over time, from data about the SU's wellbeing such as video footage obtained from cameras placed around the SU's premises.

A more subtle, and less invasive data-gathering approach is to capture data indirectly about the SU's movements and actions. Such data is obtained by use of sensors such at passive infrared (PIR) motion sensors, sensors to detect door and window closure, meters to detect use of utilities like water, electric and gas, and the like. These devices can capture information about the activity and inactivity of the SU with greater subtlety than by use of wearable devices or by video cameras, and being technologically and commercially mature technologies, are relatively reliable and inexpensive to obtain, install (especially if they are wireless) and use. Sensed atypical inactivity, in particular, can be mapped to and signify an abnormal event, such as a fall. If the system senses and interprets that such an abnormal event has indeed occurred, an alarm can be raised to the remote CPs, who can then decide how to respond. In this description, the term “event” includes the occurrence of an event (sometimes “positive event”) or, where the context permits, an absence of events (a “negative event” or “non-event”).

Here, the learning process is based on data about the SU's activities and habits gathered by a system of individual sensors or nodes within the customer's home. The “Liverpool Telecare Pilot” publication (supra.) states that the gathered data is then used as the basis for determining if a later sensing is indicative of a an event which is cause for concern. Essentially, the obtained data is stored as a statistical profile of what may be deemed to be “normal” for the particular SU, and this historical data is used as the basis of a prediction of future behaviour. Behaviour deviating from the norm (where e.g. the inter-event time value exceeds the set threshold value, or falls outside the set range of values) is categorised as an abnormal event triggering an alarm to the CP. An adaptive threshold algorithm (ATA) is used to calculate threshold values for the particular node. Thus, a node performs both the functions of detecting events to feed into this data set, and subsequently detecting events which fall outside the ATA thresholds based on the historical data. Some or all of this functionality may be centralised in a central hub device within the customer's home. This publication does not however provide any enabling or implementation details to set the threshold.

A method and mechanism to obtain such personalised threshold value, which is automatically self-adjusting to changes in the SU's condition and expectations, is thus needed to enable devices to be configured to the right sensitivity level. It is noted that the “right” level varies not only from SU to SU, but also between CPs. They may be publicly-funded bodies charged with a duty, a charitable organisation, or a privately run for-profit entity. Each will have responsibility for different SU populations of various sizes, under different geographical and other conditions (e.g. urban cf. rural communities), and have different budgets, criteria, and priorities. For this reason, there is also a need to fine-tune the sensitivity of the monitoring and response system depending on such SU and CP differences, which may be static in nature or which may change, predictably or otherwise, over time.

In a first aspect of the invention, there is provided apparatus for generating a threshold value indicative of a status change, comprising
a trend projection engine for processing a plurality of sensed values in an order of value size, to generate a corresponding predicted value for each of the plurality of sensed values, by reference to a value sequence trend of the plurality of sensed values,
a comparator for comparing one or more of the plurality of sensed values against their corresponding predicted values to identify an abnormal sensed value which differs from its corresponding predicted value by a pre-specified amount, and
a threshold generator for using the abnormal sensed value to identify the threshold value.

An implementation of the invention allows for the identification of what may be deemed to be the boundary between those inter-event time intervals which are normal and expected, and those which may be an indication that something amiss has happened—e.g. that the SU needs attention, or even that the nodes are malfunctioning. This is carried out by processing the sensed data to obtain an idea of what each value “should be” or what can be expected, based on an analysis of the trend taken by the sensed values in order or value size. In the telecare implementation example discussed here, the orderlised sensed values are therefore processed according to the duration of time elapsed between sensed events. Each piece of actual sensed data is analysed to generate a corresponding theoretical, expected value, to which the actual sensed value is then compared. It can be expected that most of the data received by the system will fall within the scope of “normality”. Where the difference between each pair of actual and expected exceeds a pre-determined amount, however, the actual sensed data value is deemed to represent an abnormality which can be adopted and used to set a threshold value. The actual threshold value adopted, based on this identification of the edge of normality, is typically an actual sensed value which is just before the abnormal value in size. Other values that may be adopted as thresholds include the predicted value corresponding to the abnormal value, or one which is within the bounds of “normality”.

Advantageously, a threshold value personalised to the particular SU which would yield more accurate results can be obtained. The process of obtaining this threshold value is computationally relatively simple and quick. It is also capable of processing data which does not conform to common distribution patterns such as the Gaussian or Weibull distributions.

In a further aspects of the invention, there are provided a remote monitoring system and separately, a telecare system, both comprising
one or more sensor nodes for generating a plurality of sensed values in response to sensed events, and
apparatus according to any preceding claim,
wherein the apparatus receives the plurality of sensed values from the one or more nodes.

A monitoring system (such as a telecare system) can advantageously use the above apparatus to discover the demarcation point or boundary between “normal” and “abnormal”, using sensed data obtained from nodes (e.g. a motion detector, a thermometer, or the like). In the event that no abnormal conditions are identified, e.g. where all the sensed data is in keeping with the projected or predicted trend, then in a preferred implementation the highest/maximum data value can be adopted as a threshold value where the system, is set up to generate a response or an alarm upon reaching or exceeding the maximum data value. Conversely, the smallest/minimum value can be adopted as the threshold value in a system arranged to respond to the minimum value. Such a “sub-optimal” system (which is so because the normal/abnormal edge of the sensed data has not (yet) been discovered, as discussed below) which are not based on the finding of an abnormal or atypical value may of course continue to operate (where the maximum/minimum values may fluctuate in dependence on the sensed data fed into the memory) until such abnormality is detected, and a point just before the normal/abnormal edge of the sensed data may be adopted and set as an optimal threshold value.

In a third aspect of the invention, there is provided a method for generating a threshold value indicative of a status change, comprising
processing a plurality of sensed values in an order of value size to generate a corresponding predicted values for each of the plurality of sensed values, by reference to a value sequence trend of the plurality of sensed values,
comparing one or more of the plurality of sensed values against their corresponding predicted values to identify an abnormal sensed value which differs from its corresponding predicted value by a pre-specified amount, and
using the abnormal sensed value to identify the threshold value.

Methods directed to remote monitoring, and separately, operating a telecare system using the method of the invention are also described.

Embodiments of the invention will now be described by way of example only with reference to the accompanying drawings in which:

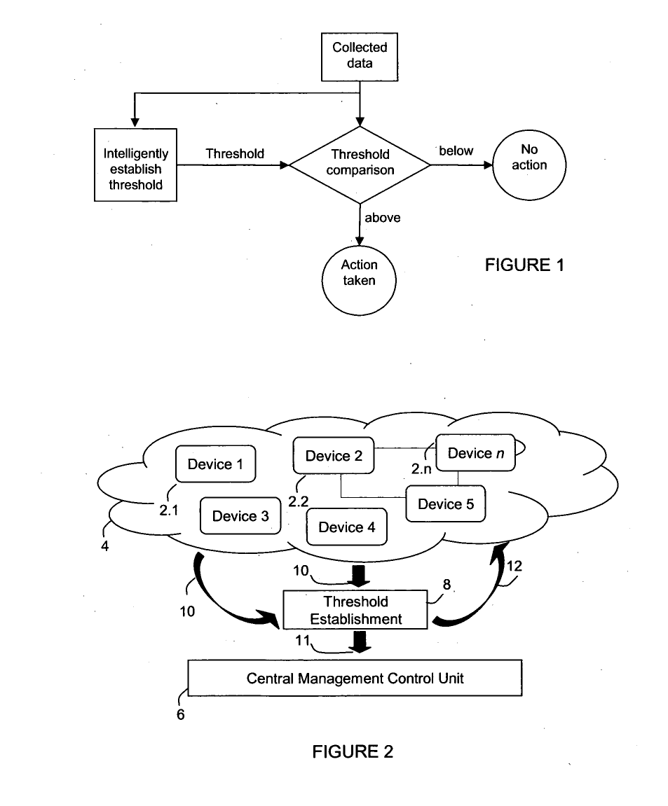

FIG. 1 is a flowchart depicting the adaptive method of setting remote monitoring threshold values;

FIG. 2 is a schematic depiction of the architecture for deriving a remote monitoring threshold value;

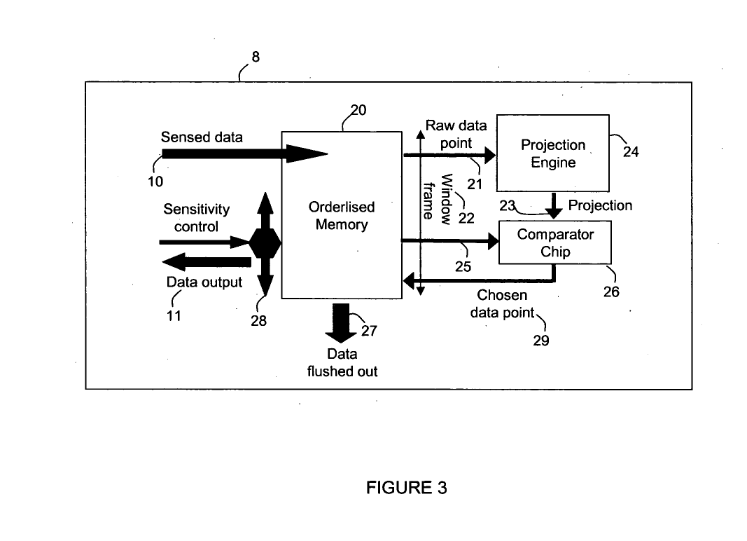

FIG. 3 depicts the components and elements of the threshold-establishment engine;

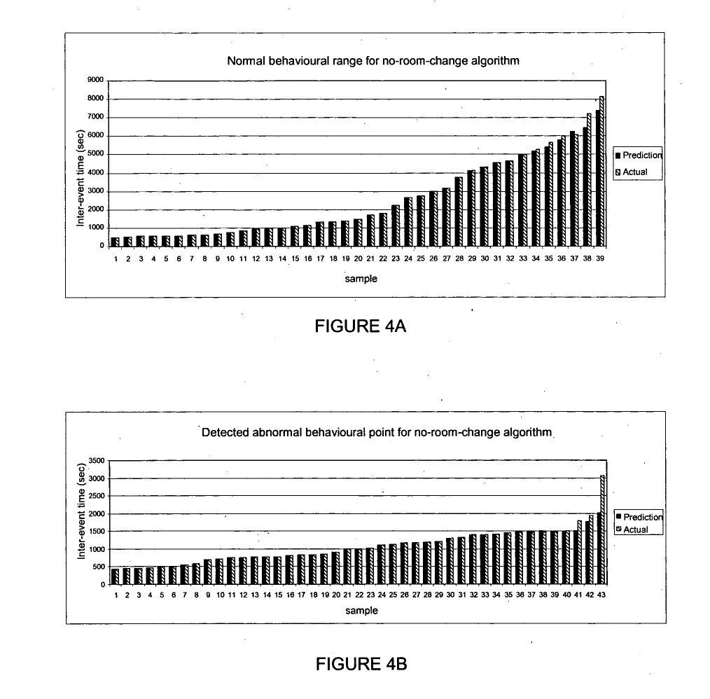

FIGS. 4A and 4B are graphs depicting the data buffered within the threshold-establishment engine;

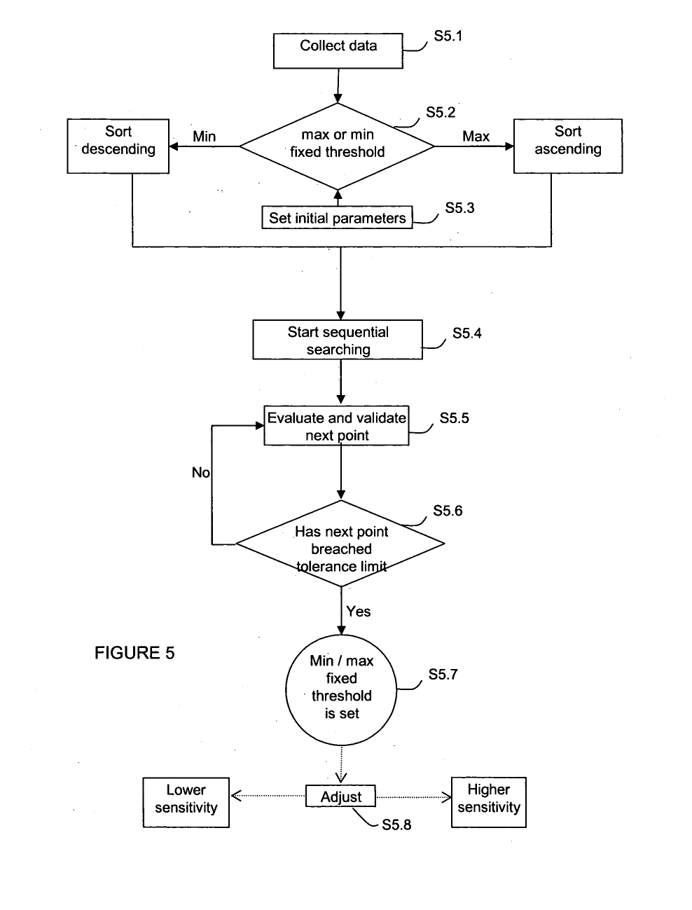

FIG. 5 is a flowchart depicting the steps in deriving a remote monitoring threshold value; and

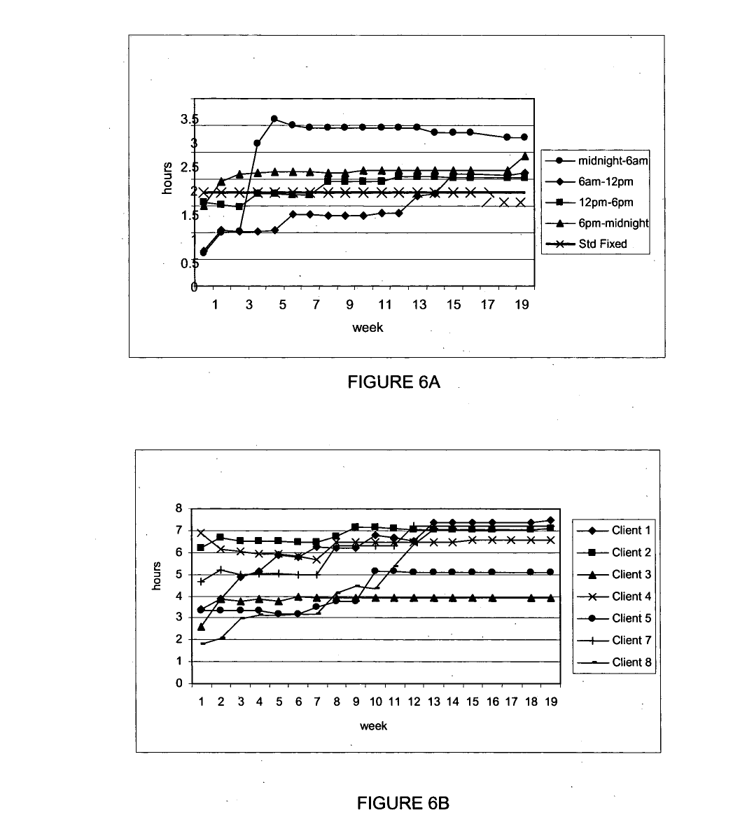

FIGS. 6A and 6B respectively depict the variations in threshold values established for a node, and between different SUs.

FIG. 1 is overview of the basic steps involved in the generation of a threshold value based on historical data gathered by sensing node(s) used in the invention of the present application. The information and the resulting threshold value can be as general or as specific as is required. For example, a CP may decide to use all the data sensed in a particular SU's premises. At increasing levels of granularity, the data from just one room (e.g. the lounge) can be used, for a particular time of day, for a particular hour, for one particular sensing node (where there may be more than one in the room), and so on. Generally, more specific information allows the derivation of a more precise threshold value for predicting whether a subsequently-detected event should be cause to raise an alarm, although there is of course a trade-off in terms of computational and implementation requirements. For example, a very generally-obtained threshold value (e.g. all data ever sensed from all the nodes in lounge) could be applied to all the lounge nodes which contributed data towards the creation of the threshold. On the other hand, a threshold value based only on sensed data between the hours of 12:00 to 14:00 from a single node positioned at a specific place in the living room, can be used by just that node to allow the telecare system to determine if an inter-event time interval sensed by that node at 12:30 is abnormal or not. This description is based on the generation of a threshold value for a specific node at a particular time interval; but it would be understood that it may be possible to generate thresholds for much more (or less) general use.

A significant advantage afforded by the use of the apparatus and method of the invention is that no prior assumptions need to be made about the distribution of the sensed data to be collected from the nodes, as the system is configured to learn from the data input from the nodes, and from there identify the border or threshold between those time intervals which represent normal SU activity, and those which indicate that the SU may need attention.

Referring now to flowchart of FIG. 1, the process to identify a personalised threshold level using the adaptive method starts with the collection of sensed event data about the SU's activities. Although it may be possible to use pre-generated data e.g. based on “someone like” the particular SU, there are of course advantages to using the SU's own information to derive his threshold value, including a greater level of personalisation. The collected data is used to generate an empirically-based threshold value which is generated or established through the learning process described below, for use by the system to identify any abnormal time intervals, but which can be changed e.g. based on further sensed data inputs, or for the purpose of sensitivity adjustment (described below in connection with FIG. 4). In this description, the term “value” may refer to more than one value, such as a range of values, where appropriate.

The threshold obtained is used for comparison purposes to determine if later-sensed events and inter-event time intervals exceed the set threshold value. A decision can be taken to take action or not in dependence on whether the sensed inter-event time falls above or below the threshold value.

FIG. 2 is a high-level depiction of the main elements of a system which generates and uses a personalised, intelligently established threshold value. A number of sensing device or nodes (e.g. motion detectors) (2.1, 2.2 . . . 2.n) are located so that the SU's activities may be detected, such as within the SU's premises (4). Depending on the level of granularity however, these nodes could be all positioned in a single room, or located across the entire community for which the CP is responsible. In the described exemplary implementation, they are disposed throughout a single SU's premises, e.g. in the form of at least one device or node per room and along corridors. In the implementation discussed here, the nodes are arranged to communicate with a hub or gateway device (not shown) typically located within the SU's premises (4) in e.g. a LAN via a wired (e.g. Ethernet) or a wireless (e.g. Wi-Fi, infra-red, Bluetooth) transmission link. The gateway device collates the sensed data from the plurality of nodes, and sends it on (arrows 10 and 11) to a central server (6) called a Central Management Control Unit (CMC unit) via an intermediate threshold-establishment engine (8).

The CMC unit is typically controlled by the CP and includes a rules-based engine which, given a threshold value for a particular node, a flag should be raised to the CP to signal that a possibly-abnormal condition has arisen e.g. when any sensed data exceeds the threshold value for that node. In this embodiment, the CMC unit is located remotely in the SU's premises and connected via a communications link e.g. via the Internet (not shown). The skilled person would however appreciate that the CMC unit's function may be distributed to the premises of each SU providing a self-contained solution which does not depend on the integrity of the Internet link between the SU and the CP's locations. One or more sensing nodes could even carry out the functions of the CMC unit, although this could make the node(s) very power-hungry.

The invention includes a threshold-establishment engine (8). This performs two key tasks: the first being to generating a baseline reference of “what normal looks like” for that SU according to sensed activity detected by a particular node, and the second being to actually identify one of the sensed time intervals as a threshold value, the exceeding of which may indicate a problem requiring CP investigation. Broadly speaking, the first of these tasks is carried out by the projection engine (24 in FIG. 3), while the latter task is performed by the comparator (26 in FIG. 3).

As shown in FIG. 2, the engine is located remote from the SU's premises. It could be however located at any point in the system so long as a preliminary set of sensed outputs for a particular node can be sent to the engine to have a threshold value established for that node, so that the CMC unit can compare subsequently-sensed inter-event time intervals from that node against the threshold for that node. In the embodiment depicted in FIG. 2, the threshold-establishment engine (8) is located on the CP side (e.g. it could be part of the CMC unit), wherein sensed data can be sent (arrow 10) to the threshold-establishment unit. Threshold values set for each node in the system by the threshold-establishment engine for one or more SU premises can then be sent (arrow 11) to the CMC unit (6), or back to the relevant node sent (arrow 12).

FIG. 3 depicts the components and elements of the threshold-establishment engine (8). This is a “learning” component into which sensed data obtained from the SU's own activities and habits are used to obtain a threshold value which, when exceeded, indicates an abnormal situation requiring CP attention.

The time elapsed between two events sensed by the particular node is calculated (e.g. by the node itself, if it includes the intelligence to perform this task, or else by the home hub, the threshold-establishment engine itself, or the like). In applications which do not refer to the time elapsed between events e.g. in the remote monitoring of machines, the sensed event or data (e.g. a sound frequency) is used to calculate the threshold value.

In this exemplary telecare implementation, the inter-event time interval data is received by the threshold-establishment engine and stored (arrow 10) in a memory (20). The memory (20) optionally has a window data frame which covers a pre-specified time period e.g. the immediately-preceding 31 days. The window can therefore be thought to be “sliding” over time, but is of a fixed size in that it covers a pre-specified time period—which may of course be fixed according to other criteria e.g. the last 10,000 nodes sensings. In this preferred embodiment, sensed data in the memory falling outside the pre-specified time period is flushed from the memory (arrow 27) as the window “slides” during everyday use. Continuing with the above example, sensed data input into the engine 32 days or more before, will be deleted from the memory. This ensures that the data used to calculate the threshold value for the node contributing the data, is constantly refreshed and up-to-date. The skilled person would appreciate that the window could be configured to any other time period (e.g. a week), and that it need not refer specifically to an immediate-past period. For example, the memory (20) may initially, at the start of August, be pre-populated with historical data from an August from a previous year (as it is known that the SU's activities during the summer are very different from those in the rest of the year). Sensed data newly fed into the fixed-sized memory will gradually displace and flush out the historical data as time goes by. The threshold-establishment engine memory for a newly-subscribed SU may also be pre-populated with “typical” values at the start until enough data about the particular SU's own activities has been sensed for generating a threshold value.

The contents of the memory are also “orderlised”, i.e. sorted into an order according to the value of each piece of sensed data. In the embodiment described, the contents in form of inter-event time intervals are orderlised in either ascending or descending order of the time interval value, which allows for the determination of the maximum or minimum threshold value (i.e. boundary).

FIGS. 4A and 4B are graphs illustrating how the orderlised data is buffered within the memory (20). Sample 13 in FIG. 4A, for example, denotes that 1,000 seconds had expired between e.g. SU activity sensed by the particular motion sensor. In these graphs, the y-axis depicts the duration (in seconds) of the time expired between two events sensed by a node. Each bar arranged along the x-axis represents an instance, or a “sample”, of actual sensed data. It is important to note that the x-axis does not, possibly contrary to expectations, represent a continuum of values, but instead depicts the sensed data in a sorted order—in this case, in ascending order of the duration of the time-interval represented. So for example, sample 28 need not necessarily have been generated prior to, or anywhere near in time, to sample 29. Actual sensed data received from the nodes is referred to as “Actual” data. Data marked “Prediction” is projected trend data generated by the projection engine (24) in the manner described below.

The sample bars along the x-axis are shown in FIGS. 4A and 4B to be equidistant from each other. The skilled person would be aware that alternative arrangements are possible: e.g. to bunch certain samples while spacing other sample evenly or unevenly. apart, which would influence the trend shape or pattern. For example, it is possible to arrange the samples so that the ascending trend pattern is a straight line, allowing for the trend information to be read from the x-axis. Such uneven arrangement of samples may also be used e.g. for weighting purposes e.g. where certain samples are of greater or lesser significance to the CP or the SU for any reason.

It is visually apparent from FIG. 4A that the actual sensed data is largely in conformity with the “normal” trend values, allowing the CP to interpret that the activities of the SU as sensed by the particular node are relatively consistent and unchanging. In contrast, the graph of FIG. 4B includes at the extreme right end of the orderlised data, an unusually high sensed inter-event time value (sample 43) which is visually distinguishable from the bulk of sensed values in the set. Such an abnormal value can also be detected using a trend projection or prediction algorithm to give the CP an idea of what may be expected at the boundary or edge of the orderlised set of sensed value data. A sensed value such as the striped bar at sample 43 can be compared against its corresponding predicted value (represented by the solid bar of sample 43).

The predicted values are generated by the projection engine (24). Turning back to FIG. 3, the projection engine is in this embodiment, part of the threshold-establishment engine (8). The main task performed by this engine is to establish the SU's normal behavioural profile is according to actual sensed data obtained from a particular node (i.e. that depicted as “Actual” data in FIGS. 4A and 4B). In FIG. 3, this actual sensed data is shown to be passed (arrow 21) to the projection engine via the memory, but of course the data can be passed to the projection engine separately as long as that data also relates to the same time period (e.g. 31 days) or other constraints as that stored in the memory.

The projection engine uses a projection or prediction algorithm e.g. the Holt Winters double exponential smoothing method, to process the orderlised sensed data. This produces a trend prediction of the orderlised actual sensed data sequence, in the manner described in greater detail below, based on and using the ordered values of a subset of the samples in the sequence. For the sake of clarity, it should be noted that the “trend” (in the cases of FIGS. 4A and 4B, along the x-axes) does not refer to changes to in time intervals over time; rather it describes the shape and pattern of the sequence itself based on the data values which have been sorted in a particular order.

The projection technique of the invention does not employ “curve fitting” in the traditional sense. However, the analysis of the smaller (or larger, depending on how the data is ordered) in the sequence or series allows for identification of a notional line or curve which describes the trend of the pattern or shape of the sensed data. This curve (which may be visually discerned from e.g. the predicted data value in samples 1 to 39 in FIG. 4A) includes an interpolated values between currently-available sensed data. Any future sensed data fed into the projection engine which fits between existing sensed values (e.g. a freshly-received node reading of 1,000 seconds may be fitted between samples 13 and 14 in FIG. 4A) may be compared against interpolated value trend data, and found to be in conformity with the predicted trend value curve.

As the skilled person would expect, it is possible also to extrapolate beyond known sensed data (e.g. beyond sample 39 in FIG. 4A) to anticipate what “should” be the “next” value on in the series or sequence.

In the implementation where the memory includes the sliding window mechanism, the oldest current value in the set is deleted, so that e.g. there will be always be 39 values represented in the graph of FIG. 4A. Upon the receipt of fresh sensed values, the notional curve changes. For example, if ten sensed values of 1,000 second each were read into the memory, the curve may flatten in shape, depending on which older values are removed.

This approach of processing an ordered set of data values, advantageously accommodates collections of all types of sensed data, regardless of their distribution. For example, it has been found by the applicants that in practice, gathered sensed telecare data may not always conform to classical distributions e.g. the Gaussian or Weibull distributions. Threshold-setting methods that can work only on such distributions cannot process such data, unlike the distribution-agnostic approach of the present invention. The skilled person would appreciate however, that in the appropriate case, the more traditional curve-fitting techniques may be employed by the threshold-establishment engine (8) in place of analysing an orderlised range of sensed values, e.g. in the case where the data distribution allows for this.

The actual process to obtain the trend projection can be carried out in the following way. After arranging the data in ascending order, the values of samples 1 and 2 of actual data of e.g. FIG. 4A, or the shape or pattern they present, is used to predict the value of sample 3. The actual sensed data of samples 1 to 3 is then used to predict the time interval of sample 4, and so on. Eventually, a prediction or projection is made for all values that may be “expected” within, and beyond, the actual sensed data range, by interpolating within the range, and extrapolating beyond the range.

This projected data trend, which may be thought in terms of a curve as discussed above, is a basis for the “normal” profile of the SU according to the particular node. A predicted value is generated to correspond with each piece of actual sensed data, and this value can be a discrete one as shown in the graph, or else can be thought to be points on the curve describing the shape of the data value in the graph.

The skilled person would appreciate that the process may be started with any of the actual sensed values available, which values need not be immediately consecutive to each other, as long as the projection or prediction is carried out consistently in ascending or descending order. The skilled person would also understand that while the sensed data should be processed in order, it is not essential to store it in that order in the memory (20). Thus, it is possible for the sensed data to be stored in the order received from the node, or in other, or in a random order, as long as there is means for the projection engine to refer the size/value of each piece of sensed data. This may be effected e.g. by reference to separately-generated information e.g. an orderlised memory address index of each of the sensed data values. However maintaining and storing the sensed data in an orderlised form is of course more computationally efficient. This also has the advantage of allowing for subsequent fine-tuning of the sensitivity of the system, as will be described further below e.g. against step S5.8 of FIG. 5, without need to again order the data.

After the sensed data has been processed to generate the predicted values, the “edge of normality” of the set of sensed data is identified. This is performed by the comparator chip (26). Referring back to FIG. 3, the comparator chip is arranged to receive the data trend information (which may take the form of discrete values, or a continuous line or curve joining the discrete data value points, or the like) generated by the projection engine (arrow 23) in a set or otherwise. The comparator also obtains from the memory (25) the orderlised list of the actual sensed data obtained from the nodes, again in a set or as separate values. The comparator compares the two sets of data. In an implementation where the value trend data comprises discrete values (e.g. as shown in FIGS. 4A and 4B), each sensed value has a corresponding “normal” value and the values of each are compared. In an alternative embodiment using a continuous line or curve representing the value, trend, each actual sensed data in the orderlised set is compared against the shape of the curve.

Any difference or variation between the corresponding values in the two data sets or with the shape of the curve is quantified, and if the difference exceeds a pre-specified amount (which may be an absolute or a relative value), that particular value can be identified as the border or boundary separating normal from abnormal. Using the data of FIG. 4B as an example, sample 43 may be found to be an abnormal value, and so sample 42 may be set as threshold value. This is because sample 42 is on the edge of normality, but still does fall within the set of “normal” values. Alternatively, the predicted value of sample 43 may be used. In any case, the CP obtains an empirically-based indication of when the inter-event time interval becomes unacceptably long.

In practice, it is often not necessary in this comparison step to process all the actual sensed data points, as the bulk of data will typically comprise values which fall within the SU's normal behavioural profile. Using an earlier example, a sensed time interval of 1,000 seconds will slot into the graph of FIG. 4A between samples 13 and 14, and may be discounted as being an unusual time interval deviating from the trend. In the main, only those sensed data values at or near the edge or boundary (e.g. samples 42 or 43 in FIG. 4B) are likely to need processing by the comparator as being possible unusual time intervals.

In a preferred implementation therefore, only the data values nearer the edge or boundary (i.e. maximum or minimum) need to be evaluated. This reduces the computation overhead required. Using FIG. 4B as an example, the CP may choose to assume that samples 1 to 21 always describe normal values for the SU, so that the comparison processes are carried out on each value only from sample 22 onwards. The corresponding predicted and the actual sensed data values in sample 22 are compared to determine how much they deviate in value from each other, specifically, if the difference in the values exceeds pre-specified value n. If it does not, then the next set of predicted/actual data values are compared, until the value n is found to be exceeded.

Depending on what the value of n is, the relatively small value differences in samples 41 and 42 may be deemed to be insufficient to exceed the value n indicating an abnormal reading, and to serve as a demarcation between the normal/abnormal. This being the case, the sensed data in sample 43 is identified as the “edge of normal”, and the actual sensed value of sample 42 is selected as the threshold value for the particular node. This value is then returned as an output (arrows 29 and 11) from the threshold-establishment engine (8) to e.g. the CMC unit (6), or to the device or node (2) which had provided the sensed data which had been processed as described above.

In a particular scenario, depicted in e.g. FIG. 4A, no significantly abnormal or atypical actual value is fed into the system, so that the value n is not found to have been exceeded by any sensed data. In such an event, the search or evaluation process will end after the last data point in the memory (i.e. sample 39), and the actual sensed value in sample 39 which will serve as a threshold value in a sub-optimal fashion, until such time when the value n is exceeded to generate a true threshold value. It is possible that the value n is never exceeded in the case of an SU whose habits are completely unvarying and/or predictable, but it is more likely that a breach will eventually occur which would be used as the threshold value.

The threshold value identified by the comparator (26) in the above manner, is preferably verified by the CP via a feedback loop. In practice, a CP will take action in response to an SU whose threshold has been exceeded. In such a case, the SU would be in two states: either they are actually in need of help (in which case the threshold has been correctly identified), or else the SU is fine (in which case the threshold value was incorrectly identified by the system). In the latter scenario, a sample such as sample 43 in FIG. 4B can be discarded by the system and the process may be run again to generate another threshold value.

The system is preferably set up to continually or periodically process new sensed data buffered into the memory, so that the projected data trend and the threshold value are updated and refreshed to reflect the currently-relevant inter-event time intervals based on the most recent data captured by the node(s). Advantageously, the system may be set up so that projected trend analysis carried out by the projection engine (24) may be performed “offline” (e.g. once a day or week). The tasks of the comparator (26) in contrast, must be carried out in real time, to determine which, if any, sensed data continually arriving from the nodes denote an abnormal time interval requiring an alarm to be raised.

The threshold value is thus identified by the system. Continuing from the above example, the SU or the CP may choose not to adopt sample 42 as the threshold value, for various reasons, such as the parties' particular circumstances and priorities as briefly noted above in the introduction. In, such a case, the threshold-establishment engine optionally and preferably includes a sensitivity controller (28) which allows for the threshold value to be adjusted in dependence on the desired level of system sensitivity to the possibility that the SU may need help. For example, a CP might adopt a policy to “err on the side of caution” and to increase the sensitivity of the system even at the risk of generating more false alarms. The sensitivity controller permits for e.g. the value of sample 41 or 40 to serve as the threshold, even if the comparator had found that the difference between the predicted and actual data values had not exceed value n. Alternatively, the SU may be annoyed with the generation of so many false alarms, and seek to adjust the sensitivity the other way (which as a matter of policy, may or may not be permitted by the CP).

One method of implementing the sensitivity control is as follows. Assume that the value at sample 39 of FIG. 4A is set as the threshold value. If the sensitivity of the system is reduced (so that an alarm will not be raised even if an inter-event time interval exceeding the set threshold value), the projection algorithm will “project forward”, or extrapolate, beyond the sample 39 to obtain a predicted value in accordance with the value trend. This will be used as the threshold value for a system with reduced sensitivity. Conversely, if the sensitivity is to be increased (so as to include time intervals that would not have breached the established threshold value), one of the sensed values smaller than the value of sample 39 is adopted as the threshold. The sensitivity controller may be thought of “sliding” up and down the memory block which holds these data-values to select one which suits the needs of the parties.

The skilled person would appreciate that other methods may be employed to adjust the system's sensitivity, for example, by the simple expedient of adding or reducing an arbitrary number of seconds to the threshold value identified by the system. Even in such a case, the original threshold value was obtained based on empirical evidence of its relevance to the SU.

The main steps of the process to establish a threshold value according to the above exemplary implementation, will now be described in the flowchart of FIG. 5.

In step S5.1, sensed data obtained from sensing nodes is collected and stored in the memory (20) of the threshold-establishment engine (8). As noted earlier, data of finer granularity should allow the generation of a more accurate threshold value. The collected data is orderlised in step S5.2 in ascending or descending order in the memory (20). The CP (or SU or other party having control of this aspect of the telecare service or system) selects in step S5.3, the initial parameters to be used. These concern whether the order the sensed data in the memory is in an ascending or descending order (which would affect whether a maximum or minimum threshold value is to be identified), the window frame size, pre-specified value n, the evaluation starting point in the orderlised data, the pre-determined threshold value used in a newly-set up system, and so on.

Based on the data in the memory and the initial -parameters, an initial threshold value is set by searching, evaluating and validating each data point iteratively as described above (steps S5.4 to S5.7). Subsequently, the threshold value can be adjusted in step S5.8 as required.

By use of the method and apparatus of the invention, personalised and current threshold(s) can be set for each SU, for each room and for each node. As is shown in the graphs of FIGS. 6A and 6B which cover a 20-week period, the threshold values established using the method of the invention may vary considerably. The data in FIG. 6A shows how the activities of an SU in just one room (the lounge) can vary significantly depending on the time of day and over the 20-week period. The varying threshold values established by the method as shown in this graph can be contrasted with the static, fixed threshold value set, in this example at about 1.8 hours—so that an alarm may be generated if the node in the lounge fails to sense activity or the like after 1.8 hours. It can be seen how this could result in the generation of many false alarms (e.g. after midnight from week 4 onwards), and more significantly, fail to flag up situations when help may actually be required by the SU (e.g. between 06:00 and 12:00 up to week 14).

FIG. 6B similarly shows how threshold values between SUs can vary considerably even within the same room type and over same time period (bedroom, 00:00 to 06:00). A factory pre-set threshold value would work very poorly in these circumstances.

After the establishment (and any sensitivity adjustment) of the threshold value using the above exemplary methods and apparatus, the threshold value is adopted and set for e.g. the particular node. Subsequent sensed data obtained from that node is measured against the set threshold level. If the subsequent inter-event time interval exceeds the threshold value, this may be a trigger to raising an alarm for CP action. In a preferred implementation, the subsequently-sensed data continues to be fed into the threshold-establishment engine (8) so that the memory (20) is constantly refreshed, allowing for the threshold value to be continually or periodically updated so that it remains current.

The methods and configurations as described above and in the drawings are for ease of description only and not meant to restrict the apparatus or methods to a particular arrangement or process in use. In particular, the methods and apparatus described are merely exemplary and may be usefully deployed in any remote monitoring system. In the same vein as the above examples pertaining to the remote monitoring of the condition of factory plant and machinery, it would be appreciated that the receipt of abnormal or unexpected values in the telecare context could be a result from malfunctioning components within the telecare system, e.g. that the nodes, central hub, the projection engine and the like, are not working as they should. It should be noted that if the malfunctioning value falls within the normal profile range, this will still not be detected. Only abnormal malfunctioning values can be detected.

It will be apparent to the skilled person that various sequences and permutations on the methods and apparatus described are possible within the scope of this invention as disclosed.

1. Apparatus for generating a threshold value indicative of a status change, comprising
a projection engine for processing a plurality of sensed values in an order of value size, to generate a corresponding predicted value for each of the plurality of sensed values, by reference to a value sequence trend of the plurality of sensed values,
a comparator for comparing one or more of the plurality of sensed values against their corresponding predicted values to identify an abnormal sensed value which differs from its corresponding predicted value by a pre-specified amount, and
a threshold generator for using the abnormal sensed value to identify the threshold value.

2. Apparatus according to dam 1 wherein the threshold generator identifies one of the plurality of sensed values other than the abnormal sensed data, as the threshold value.

3. Apparatus according to claim 1 wherein the trend projection engine is arranged to process the plurality of sensed values in ascending or descending order of value size, and wherein the apparatus further includes a memory for storing the plurality of sensed values in the order of size.

4. Apparatus according to claim 3 wherein the memory is arranged to perform one or both of
receiving fresh sensed values to include in the memory, and
flushing stale sensed values from the memory.

5. Apparatus according to dam 5 wherein the memory is arranged to flush stale sensed values upon receipt of the fresh sensed values.

6. Apparatus according to claim 1 further including adjustment means arranged to allow a user to adjust the threshold value by adopting another one of the plurality sensed value or a predicted value, the adjustment being based on user input.

7. Apparatus according to claim 1 wherein if no abnormal sensed value is identified by the comparator, the threshold generator is arranged to identify the largest sensed value or its corresponding predicted value and/or the smallest sensed value or its corresponding predicted value, as the threshold value.

8. A remote monitoring system comprising
one or more sensor nodes for generating a plurality of sensed values in response to sensed events, and
apparatus according to claim 1,
wherein the apparatus receives the plurality of sensed values from the one or more nodes.

9. A telecare system comprising the apparatus of claim 1 wherein the sensed values comprise inter-event time intervals between sensed events.

10. A telecare system comprising a remote monitoring system of claim 8 wherein the readings comprise inter-event time intervals between sensed events.

11. A method for generating a threshold value indicative of a status change, comprising
processing a plurality of sensed values in an order of value size to generate a corresponding predicted values for each of the plurality of sensed values, by reference to a value sequence trend of the plurality of sensed values,
comparing one or more of the plurality of sensed values against their corresponding predicted values to identify an abnormal sensed value which differs from its corresponding predicted value by a pre-specified amount, and
using the abnormal sensed value to identify the threshold value,

12. A method according to claim 11 wherein the step of using the abnormal sensed value comprise the identification of one of the plurality of sensed values other than the abnormal sensed data, as the threshold value.

13. A method according to claim 11 further including the step of storing the plurality of sensed values in the order of size.

14. A method according to claim 13 wherein the storage step comprises storing the plurality of sensed values in ascending or descending order.

15. A method according to claim 11 wherein the processing step comprises generating corresponding predicted values by
using of a value sequence trend prediction algorithm to process at least two of the plurality of sensed values to obtain a predicted value corresponding to another one of the plurality of sensed values,
iteratively using the prediction algorithm on the at least two and the another of the plurality of sensed values, to obtain a yet further predicted value corresponding to yet another one of the plurality of sensed values, until all plurality of sensed values have been processed.

16. A method according to claim 11 including a preliminary step of receiving the plurality of sensed values from one or more sensor nodes, and the further steps of
receiving fresh sensed values and/or flushing stale sensed values being older than a pre-specified age,
processing part or all of the plurality of fresh values to obtain fresh predicted values,
comparing a sensed value with its corresponding fresh predicted values, and identifying an abnormal sensed value.

17. A method according to darn 16 wherein, if the sensed value does not differ from the predicted values by the pre-specified amount, the comparison step further comprises iteratively comparing a further sensed value with its corresponding predicted value until an abnormal sensed value is identified.

18. A method according to claim 11 wherein if no abnormal sensed value is identified, then the largest and/or the smallest sensed value is used to identify the threshold value.

19. A method according to claim 11 further including the step of adjusting the identified threshold value by adopting another of the plurality of sensed values or a predicted value, such adjustment being based on user input.

20. A remote monitoring method comprising the steps of a method according to claim 11.

21. A method of operating a telecare system comprising the steps of a method according claim 11 wherein the sensed values comprise inter-event time intervals between sensed events.
